(19) United States
(12) Patent Application Publication
(10) Pub. No.: US 2005/0156865 A1
(43) Pub. Date: Jul. 21, 2005

(54) Flat panel display driver for location recognition

(75) Inventor: Myoung-Sik Suh, Suwon-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/028,868

(22) Filed: Jan. 4, 2005

(30) Foreign Application Priority Data
Jan. 5, 2004 (KR) 2004-365

(51) Int. Cl. G09G 3/36

(52) U.S. Cl. 345/100

(57) ABSTRACT

A flat panel driver includes a shift register that receives a control signal input from an external device in synchronization with a clock signal, adds/subtracts a predetermined pulse width to/from the pulse width of the control signal and, when a predetermined function of the driver is completed, outputs the control signal having the adjusted pulse width such that the driver can recognize its location in the flat panel through input/output signals and the driving characteristic of the driver can be varied to optimize the performance of the driver.

### CROSS-REFERENCE TO RELATED APPLICATION

This application claims foreign priority under 35 U.S.C. § 119 to Korean Patent Application No. 2004-365, filed on Jan. 5, 2004, in the Korean Intellectual Property Office, the disclosure of which is incorporated herein by reference in its entirety.

### BACKGROUND OF THE INVENTION

1. Field of the Invention

The present disclosure relates to flat panel displays, and more particularly, to flat panel display drivers for use in flat panel displays.

2. Description of the Related Art

Information processed by an information processor has an electrical signal form. In order for a user to confirm information processed by the information processor with the naked eye, a display serving as an interface is required.

Recently, flat panel displays including a liquid crystal display are replacing CRT displays because flat panel displays are lighter and thinner than CRT displays. Furthermore, flat panel displays are environment-friendly and consume little power.

The liquid crystal display, one type of flat panel display, is a display device that uses modulation of light by liquid crystal cells. The liquid crystal display applies a voltage to a specific arrangement of liquid crystal molecules to change the molecule arrangement, and converts a variation in optical characteristics of liquid crystal cells that emit light according to the changed molecule arrangement, such as birefringence, polarity, dichromatism, and light scattering, into a variation in visual angle.

A plasma display panel (PDP) is constructed in such a manner that a large number of cells are formed on two glass substrates having electrodes, and the cells are filled with a discharge gas at a predetermined pressure and sealed up. When the electrodes are provided with power, ultraviolet rays are generated by gas discharge and excite fluorescent materials to generate visible rays, thereby constructing a display image. Accordingly, the plasma display panel is also called a gas discharge display because it uses gas discharge in a plasma ion state.

In general, a flat panel display such as the liquid crystal display and plasma display panel includes a gate driver for driving gate lines of a display panel, and a source driver for driving source lines of the panel. The gate driver applies a high voltage to the panel to make the panel conductive, and then the source driver applies a gray scale voltage (an output signal of the source driver) for displaying colors to each of the source lines, thereby displaying an image on the panel.

More specifically, the source driver receives n-bit color data per one pixel to be displayed on the panel from a processor, pixel-by-pixel. The source driver receives color data corresponding to pixels of one gate line of the panel and latches the color data. After the source driver latches all the color data corresponding to one of the gate lines of the panel, the source driver multiplexes all the color data of one gate line to color data of each pixel, and simultaneously applies voltages for displaying colors to the panel, line-by-line. Here, the gate driver applies a high voltage to only one of the gate lines to store the color data supplied to the source lines in the corresponding gate line such that a corresponding color is displayed.

FIG. 1 shows a conventional flat panel display. Referring to FIG. 1, the flat panel display 100 includes a flat panel 102 on which a pixel array is formed, a source printed circuit board (PCB) 104, a plurality of flexible circuit boards 106, source drivers 108 respectively formed on the plurality of flexible circuit boards 106, a gate PCB 110, a plurality of flexible circuit boards 112, and gate drivers 114 respectively formed on the plurality of flexible circuit boards 112.

The source drivers 108 and gate drivers 114 are formed in a plurality of blocks. Thus, a control signal output from a timing controller is received by the source driver or gate driver that is the nearest to the timing controller and then transmitted to an adjacent source driver and gate driver through shift registers. A start pulse and a carry signal are delivered to a first source driver and a first gate driver. The start pulse is transmitted from the timing controller.

The operation of the gate drivers will now be explained. When the carry signal is input to the first gate driver, the first gate line is turned on, and then the next gate line is turned on in synchronization with a horizontal synchronization signal. When the last gate line of the first gate driver is turned on, the carry signal is transmitted to the second gate driver adjacent to the first gate driver, and the first gate line of the second gate driver is turned on in synchronization with the next horizontal synchronization signal.

The operation of the source drivers will now be explained. When the carry signal is delivered to the first source driver nearest to the timing controller, video data is first stored in the leftmost data register of the first source driver. When video data has been stored in the last data register of the first source driver, the first source driver is disabled. The second source driver receives the carry signal to be in a standby state before the first source driver is disabled. When all the data registers of the first source driver are full of video data, video data is stored in data registers of the second source driver. In this manner, video data is sequentially stored in data registers of the first through Nth source drivers.

As the flat panel display's size and number of pixels are increased, a voltage actually recognized when data output from the source driver 108 arrives at the first gate line becomes different from a voltage actually recognized when the data reaches the last gate line. For example, when a source driver applies a gray scale voltage that expresses a specific color, the original color is displayed properly if it is displayed through pixels of the first gate line. However, if the color is displayed through pixels of the last gate line, a color different from the original color may be displayed because the voltage is recognized to be lower than the gray scale voltage initially applied by the source driver.

In this case, the gray scale voltage output from the source driver should be compensated according to locations of the gate lines and gate drivers in the flat panel display. That is, driving characteristics of a gate driver that applies a voltage to pixels near to the output of the source driver and a gate driver that applies a voltage to pixels distant from the output of the source driver should be set differently from each other corresponding to variations in the voltage output characteristics of the source driver.

The above phenomenon also occurs in a gate on voltage output from a gate driver. The gate driver turns on and off the gates of TFTs of liquid crystal cells of a TFT-LCD panel, for example. The voltage recognized by liquid crystal cells near to the output of the gate driver is different from the voltage recognized by liquid crystal cells distant from the output of the gate driver due to an RC delay in the display panel. In this case, driving characteristics of a source driver that applies a voltage to the liquid crystal cells near to the output of the gate driver and a source driver that applies the voltage to the liquid crystal cells distant from the output of the gate driver should be set differently from each other.

To set the driving characteristics of the gate drivers and source drivers differently depending on positions of pixels, locations of the gate drivers and source drivers in the flat panel display must be recognized. That is, when the gate drivers and source drivers receive a control signal from the timing controller, an order in which the control signal is received should be recognized.

The present disclosure addresses the recognition of locations of gate drivers and source drivers, which is increasingly required as the sizes of flat panel displays increase.

### SUMMARY OF THE INVENTION

The present disclosure provides a flat panel display driver for location recognition in a flat panel display. The present disclosure also provides a flat panel display that can optimize the performance of each of a plurality of drivers for driving the flat panel display by recognizing locations of the drivers.

According to an aspect of the present disclosure, there is provided a driver for driving a flat panel display that includes a shift register. The shift register receives an external control signal, adds/subtracts a predetermined pulse width to/from the pulse width of the control signal in synchronization with a clock signal, and when a predetermined function of the driver is completed, outputs the control signal having an increased/decreased pulse width.

Preferably, the shift register may further include a control signal input unit that receives the external control signal, a pulse width detector that detects the pulse width of the control signal, a signal adding/subtracting unit that adds/subtracts the predetermined pulse width to/from the pulse width of the control signal, and a control signal output unit that outputs the resultant control signal.

According to another aspect of the present disclosure, there is provided a driver for driving a flat panel display that includes a shift register that receives a carry signal output from an external timing controller or an adjacent driver and changes the pulse width of the carry signal depending on locations of the drivers to represent the locations of the drivers.

Preferably, the shift register can change the pulse width of the carry signal by adding/subtracting a predetermined pulse width to/from the pulse width of the carry signal.

According to another aspect of the present disclosure, there is provided a flat panel driver having a shift register block. The shift register block includes a shift register, and first and second input/output circuits. The shift register decides a signal shifting direction depending on a state of a control signal. The first input/output circuit receives a first carry signal in response to a state of the control signal, detects the pulse width of the first carry signal and outputs a first internal signal having a predetermined pulse width to the shift register. Otherwise, the first input/output circuit receives a second internal signal output from the shift register in response to a state of the control signal and outputs the second internal signal as a second carry signal. The second input/output circuit receives the first internal signal in response to a state of the control signal and outputs the first internal signal as a third carry signal. Otherwise, the second input/output circuit receives a fourth carry signal in response to a state of the control signal, detects the pulse width of the fourth carry signal and outputs the second internal signal having a predetermined pulse width to the shift register.

Preferably, the first and second input/output circuits add/subtract a predetermined pulse width to/from the pulse widths of the carry signals input thereto and output the resultant carry signals to the shift register.

According to another aspect of the present disclosure, there is provided a driver block including a plurality of drivers for driving a flat panel display. The plurality of drivers are arranged at predetermined intervals and serially connected. Each of the drivers includes at least one bidirectional input/output port. The pulse width of a carry signal output from the bidirectional input/output port of each of the drivers is proportional to a distance between a corresponding driver and a reference driver. A signal shifting direction of the bidirectional input/output port of each of the drivers is decided based on a control signal.

Preferably, the bidirectional input/output port outputs a carry signal having a pulse width that is obtained by adding/subtracting a predetermined pulse width to/from the original pulse width of the carry signal to an adjacent driver.

### BRIEF DESCRIPTION OF THE DRAWINGS

The above and other features and advantages of the present disclosure will become more apparent by describing in detail exemplary embodiments thereof with reference to the attached drawings in which:

FIG. 1 shows a conventional flat panel display;

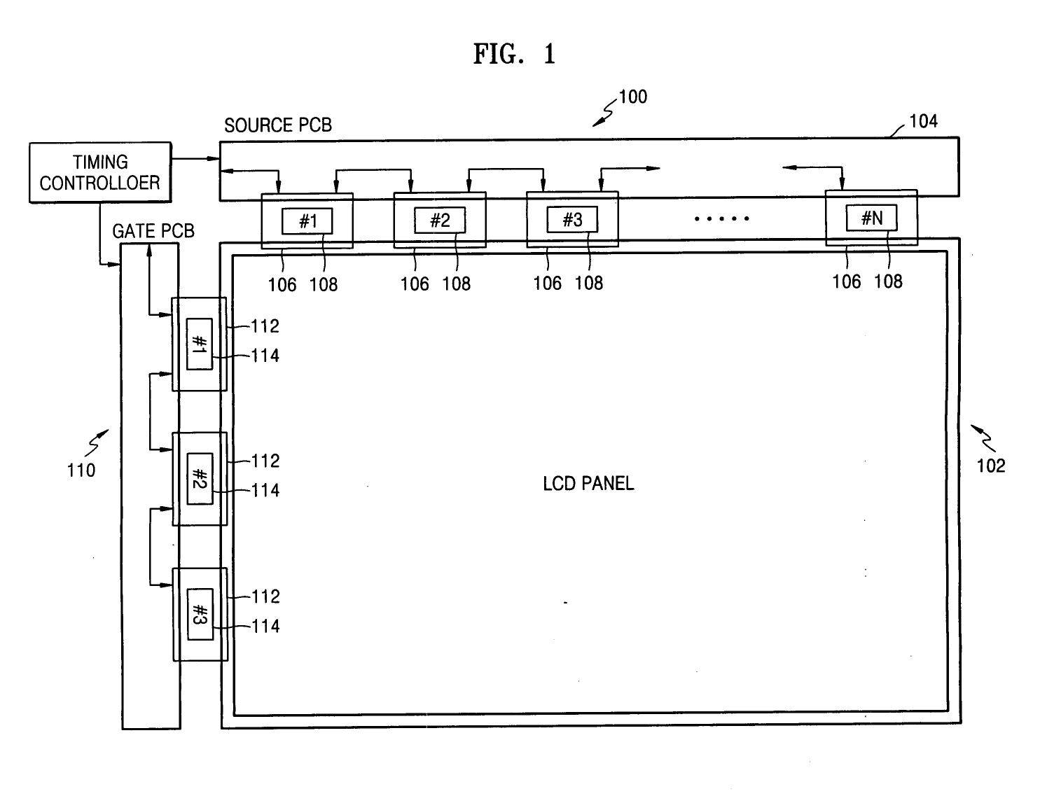

FIG. 2 is a block diagram of a conventional gate driver;

FIG. 3 is a block diagram of a conventional source driver;

FIG. 4 is a timing diagram of a carry signal used in a general source driver;

FIG. 5 is a block diagram of a shift register of a driver according to an embodiment of the present disclosure;

FIG. 6 is a block diagram of a shift register according to another embodiment of the present disclosure;

FIG. 7 shows a connection state of source drivers according to the present disclosure; and

FIG. 8 is a timing diagram of a carry signal according to the present disclosure.

### DETAILED DESCRIPTION OF PREFERRED EMBODIMENTS

Embodiments of the present disclosure will now be described more fully with reference to the accompanying drawings, in which exemplary embodiments are shown. The invention may, however, be embodied in many different forms and should not be construed as being limited to the embodiments set forth herein; rather, these embodiments are provided so that this disclosure will be thorough and complete, and will convey the concept of the invention to those skilled in the art. Throughout the drawings, like reference numerals and characters may refer to like elements.

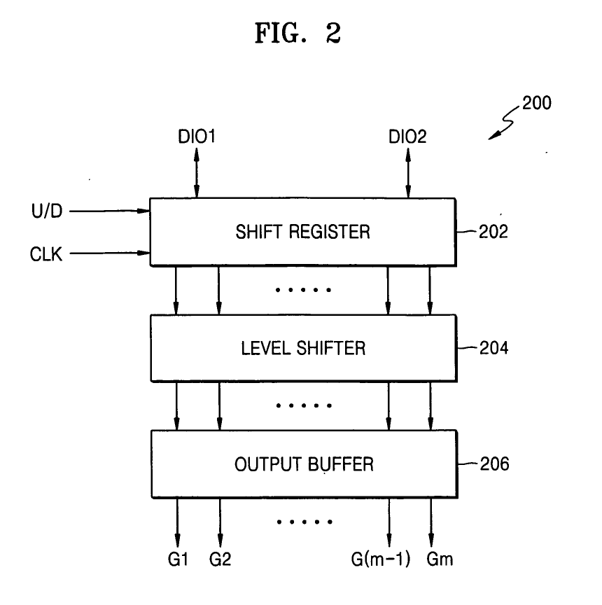

FIG. 2 is a block diagram of a conventional gate driver. Referring to FIG. 2, the gate driver 200 includes a shifter register 202, a level shifter 204, and an output buffer 206. The shift register 202 receives a main clock signal CLK, a carry signal, and a shifting direction select signal U/D used for deciding a direction of shifting the carry signal. The shift register 202 inputs and/or outputs the carry signal to and/or from an adjacent gate driver through ports DI01 and DI02. The shifting direction select signal U/D determines input and output directions of the carry signal.

If a down signal D is input to the shift register 202 as the shifting direction select signal, the carry signal is input through the port DI01 and the first gate line G1 is turned on. Then, the second through last gate lines G2 through Gm are sequentially turned on in synchronization with a clock signal. When the last gate line Gm is turned on, the shift register 202 transmits the carry signal to an adjacent gate driver through the port DI02.

If an up signal U is input as the shifting direction select signal to the shift register 202, the carry signal shifting direction is changed such that the carry signal is input to the shift register 202 through the port DI02. Then, the gate driver 200 sequentially turns on the gate lines and outputs the carry signal to an adjacent gate driver through the port DI01.

The level shifter 204 changes a voltage level in order to supply a voltage having a level sufficient to turn on a gate of each of the pixels of the flat panel display. The output buffer 206 sequentially provides the voltage output from the level shifter 204 to the gate lines G1 through Gm of the flat panel display.

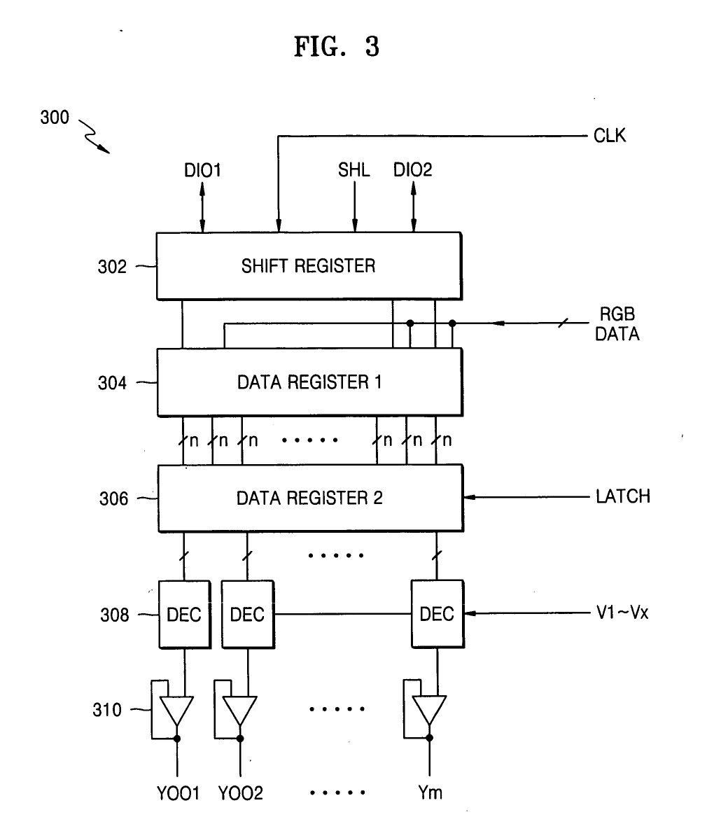

FIG. 3 is a block diagram of a conventional source driver. Referring to FIG. 3, the source driver 300 includes a shift register 302, a first data register block 304, a second data register block 306, a decoder 308, and an output buffer 310.

The shift register 302 of the source driver 300 functions in the same manner as the shift register 202 of the gate driver 200 of FIG. 2. The shift register 302 has a port for receiving the main clock signal CLK, ports DI01 and DI02 for inputting and outputting the carry signal, and a port for receiving a shifting direction select signal SHL. The shift register 302 inputs and/or outputs the carry signal to and/or from an adjacent source driver through the ports DI01 and DI02 in response to the shifting direction select signal SHL. The shifting direction select signal SHL decides a carry signal shifting direction.

The shift register 302 receives the carry signal from a timing controller or a previous source driver and stores RGB video data in the first data register block 304. When the video data has been stored in the last register of the first data register block, the shift register 302 transmits the carry signal to an adjacent source driver and disables the source driver 300. When the shift register 302 shifts the carry signal to the right in response to the shifting direction select signal SHL, for example, the shift register 302 receives the carry signal through the port DI01 and stores video data in the first data register block 304. Then, the shift register 302 transmits the carry signal to an adjacent source driver through the port DI02. On the other hand, when the shift register 302 shifts the carry signal to the left in response to the shifting direction select signal SHL, the shift register 302 receives the carry signal through the port DI02 and stores the video data in the first data register block 304. Then, the shift register 302 transmits the carry signal to an adjacent source driver through the port DI01.

The first data register block 304 sequentially stores the RGB video data in registers thereof. When the registers of the first data register block 304 are full of the video data, the first data register block 304 moves the video data to the second data register block 306 and empties the registers thereof such that they can receive new video data. The video data stored in the second data register block 306 is output to the decoder 308 in response to a latch signal. The decoder 308 decodes an n-bit digital video signal into a corresponding gray scale voltage. The gray scale voltage is provided by an external gray scale voltage generator (not shown). The decoded digital video signal is transmitted to the pixels of the flat panel through the output buffer 310.

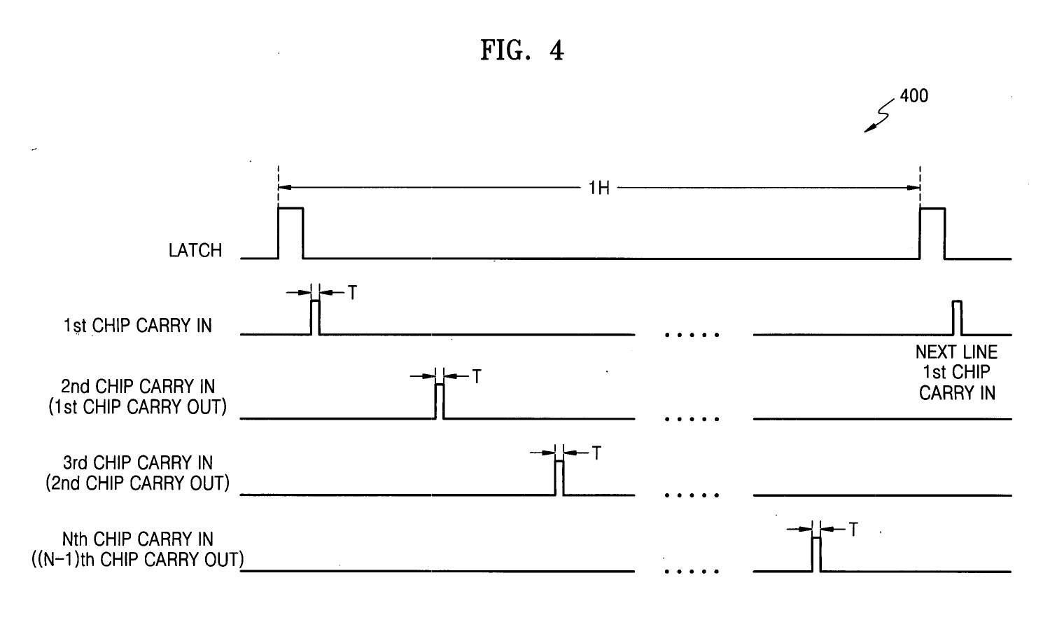

FIG. 4 is a timing diagram, indicated generally by the reference numeral 400, of a carry signal used in a general source driver. If there are N vertical pixels in the flat panel, the flat panel display has N gate lines. After the first gate line is turned on for a period 1H, the second gate line is turned on and the first gate is turned off. When the third through Nth gate lines are turned on in the same manner, this operation is repeated such that the first gate line is turned on again. If video data is output to the display at a rate of 30 frames per second, a time interval of sequentially turning on each of the first through Nth gate lines corresponds to 1/30^{th} of a second.

Referring to FIG. 4, when a period required for one gate line to be turned on is 1H, a latch signal LATCH used for a source driver to output video data is applied with a period 1H. That is, when one gate line is turned on, an image corresponding to video data of one line is displayed on the flat panel and, when the next gate line is turned on, an image corresponding to video data of the next line is displayed on the flat panel.

Furthermore, a period required for the first source driver to receive a first carry signal 1st CHIP CARRY IN, to output video data to the flat panel, and to receive the next first carry signal NEXT LINE 1st CHIP CARRY IN, also correspond to 1H. In the case where the flat panel display has N source drivers, the first carry signal 1st CHIP CARRY IN input to the first source driver through the Nth carry signal Nth CHIP CARRY IN input to the Nth source driver are sequentially transmitted for the period 1H.

As shown in the timing diagram 400 of FIG. 4, the carry signals input to the respective source drivers have the same pulse width T. The carry signals transmitted to the respective gate drivers also have the same pulse width.

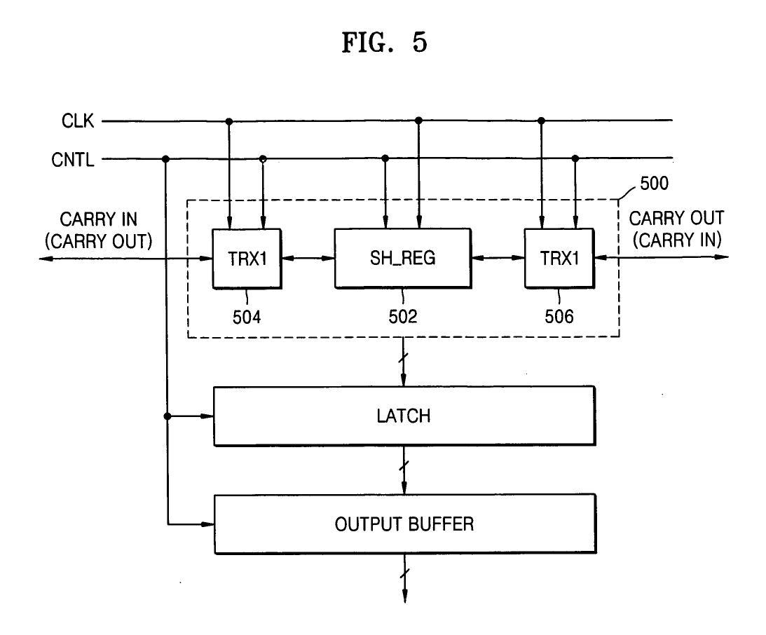

FIG. 5 is a block diagram of a shift register of a driver according to an embodiment of the present disclosure for location recognition in a flat panel display. Referring to FIG. 5, a shift register block 500 according to the present disclosure includes a shift register 502, plus first and second input/output units 504 and 506. The shift register 502 is similar to the conventional shift registers 202 and 302 shown in FIGS. 2 and 3. The first and second input/output units 504 and 506 can be located at both ends of the shift register 502. The first and second input/output units 504 and 506 receive a carry signal or change the pulse width of the carry signal.

In FIG. 5, CLK denotes a main clock signal. A control signal CNTL decides a carry signal shifting direction and whether each of the first and second input/output units 504 and 506 serves as an input unit or an output unit. That is, the control signal CNTL corresponds to the shifting direction select signal U/D in the gate driver of FIG. 2 and to the shifting direction select signal SHL in the source driver of FIG. 3.

When the first or second input/output unit 504 or 506 is operated as an input unit, it receives the carry signal from a timing controller or an adjacent driver serially connected to the driver and detects the pulse width of the received carry signal. In addition, the first and second input/output units 504 and 506 add or subtract a predetermined pulse width to or from the detected pulse width of the carry signal and transmit the resultant carry signal to the shift register 502. When the first or second input/output units 504 or 506 is operated as an output unit, it receives an internal signal from the shift register 502 and transmits the internal signal as a carry signal to an adjacent driver serially connected to the driver.

The addition or subtraction of the predetermined pulse width to or from the pulse width of the carry signal can be decided depending on a carry signal shifting direction. For example, when the first input/output unit 504 serves as an input unit and the second input/output unit 506 serves as an output unit, the carry signal is shifted to the right and the predetermined pulse width is added to the pulse width of the carry signal. When the first input/output unit 504 serves as an output unit and the second input/output unit 506 serves as an input unit, the carry signal is shifted to the left and the predetermined pulse width is subtracted from the pulse width of the carry signal.

Here, the carry signal delivered to an adjacent driver has a pulse width obtained by adding or subtracting the predetermined pulse width to/from the original pulse width of the carry signal. If a first carry signal input to a first driver has a pulse width T, for example, a predetermined pulse width P can be added to the pulse width T. Accordingly, an Nth carry signal has a pulse width corresponding to T+P*(N−1). Furthermore, the pulse width P can be identical to the pulse width T of the carry signal. In this case, the pulse width of the first carry signal input to the first driver becomes T, the pulse width of the second carry signal input to the second driver becomes 2T, and the pulse width of the Nth carry signal input to the Nth driver becomes NT. The exemplary embodiment shift register block 500 can be used as the shift register of the source driver or as the shift register of the gate driver.

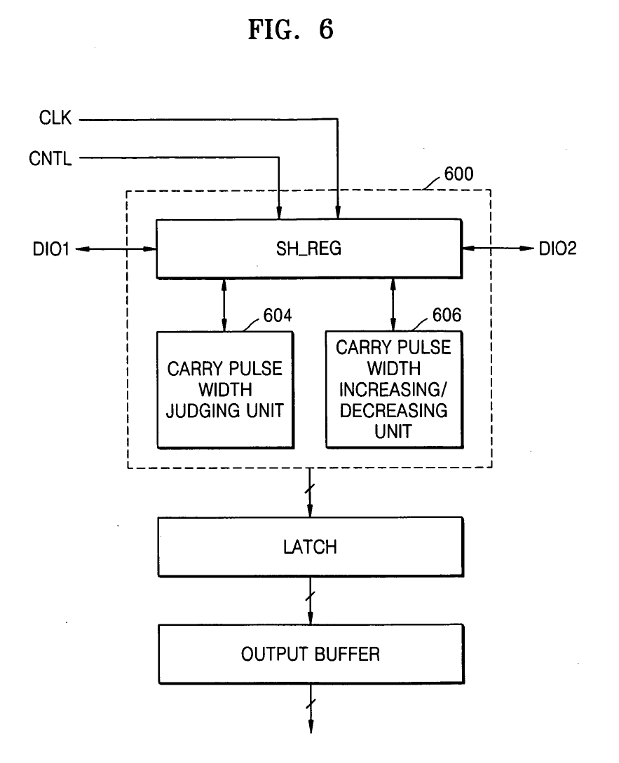

FIG. 6 is a block diagram of a shift register according to another embodiment of the present disclosure. Referring to FIG. 6, a shift register block 600 of the present disclosure includes a shift register 602, plus a carry signal pulse width judging unit 604, and a carry signal pulse width increasing/decreasing unit 606.

The shift register 602 is similar to the conventional shift registers 202 and 302 shown in FIGS. 2 and 3. The carry signal pulse width judging unit 604 judges the pulse width of the carry signal input to the shift register 602. The carry signal pulse width increasing/decreasing unit 606 adds or subtracts a predetermined pulse width to/from the pulse width of the input carry signal in response to a control signal CNTL applied to the shift register 602, respectively. 5 Referring to FIG. 6, carry signal input/output ports DI01 and DI02 receive the carry signal input to the shift register 602 or output the carry signal to an adjacent driver serially connected to the driving including the shift register block 600. In FIG. 6, CLK denotes a main clock signal. The control signal CNTL determines a carry signal shifting direction and whether each of the input/output ports DI01 and DI02 serve as an input unit or an output unit.

This embodiment of the present disclosure can recognize the location of the driver in the flat panel display when the carry signal pulse width judging unit 604 judges the pulse width of the carry signal. Based on this information, the embodiment can set driving characteristics of a source driver near to the output of a gate driver and a source driver distant from the output of the gate driver differently from each other. Similarly, the present embodiment can set driving characteristics of a gate driver near to the output of a source driver and a gate driver distant from the output of the source driver differently from each other.

In the case of a large flat panel display, the display can normally display an image according to the recognition of locations of the drivers and compensation of driving characteristics of the drivers based on the recognized locations.

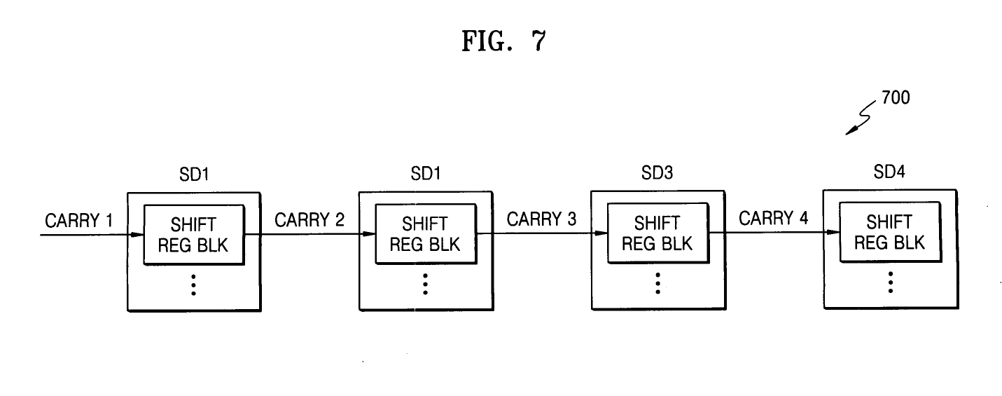

FIG. 7 shows a connection state of source drivers according to the present disclosure and indicated generally by the reference numeral 700. Referring to FIG. 7, each of the plurality 700 of source drivers is serially connected. Each of the source drivers SD1, SD2, SD3 and SD4 receives a carry signal to be enabled, and it is disabled after storing video data. A predetermined pulse width is added to or subtracted from the pulse width of the carry signal while the carry signal passes through the source drivers.

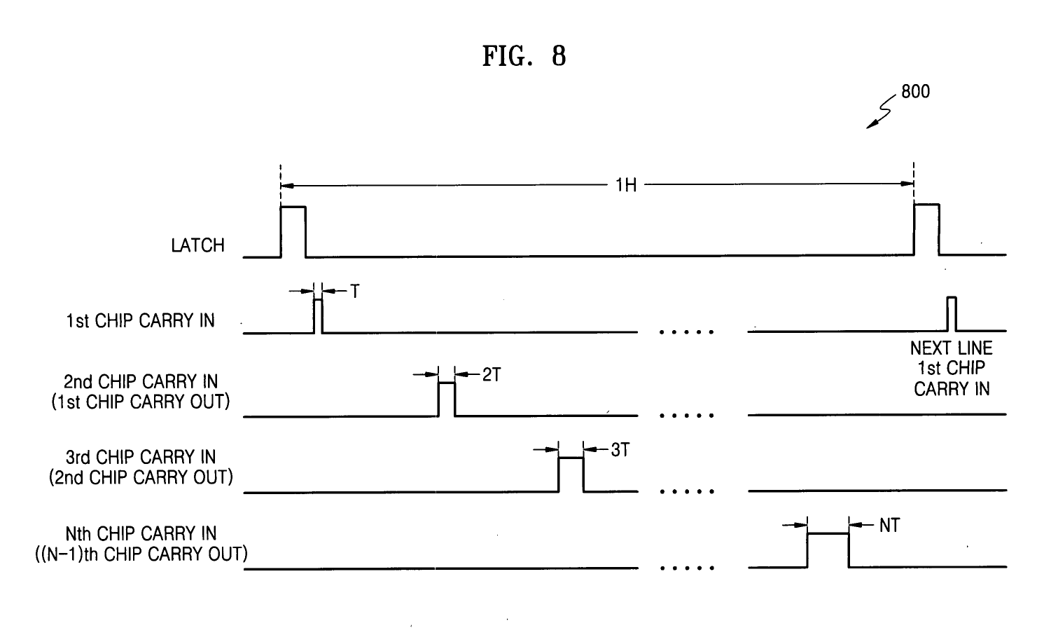

FIG. 8 is a timing diagram of a carry signal indicated generally by the reference numeral 800, according to an embodiment of the present disclosure. Referring to the diagram 800 of FIG. 8, when a period required for one gate line to be turned on is 1H, a latch signal LATCH used for a source driver to output video data is applied with a period 1H. Furthermore, a period required for a first source driver to receive a first carry signal 1st CHIP CARRY IN, to output video data to the flat panel, and to receive the next first carry signal NEXT LINE 1st CHIP CARRY IN, also corresponds to 1H. When the flat panel display has N source drivers, the first carry signal 1st CHIP CARRY IN input to the first source driver through the Nth carry signal Nth CHIP CHARRY IN input to the Nth source driver are sequentially transmitted for the period 1H.

Referring to FIGS. 7 and 8, when the timing controller transmits the carry signal to the leftmost source driver among the drivers, the carry signal is shifted to the right. Here, the carry signal input to the first source driver has a predetermined pulse width T. The first source driver judges the pulse width of the carry signal to be T to recognize that the location of the source driver within the flat panel is the first location.

The first source driver adds a predetermined pulse width (T in FIG. 8) to the pulse width T of the carry signal to transmit the carry signal having the pulse width 2T to the second source driver. The second source driver judges the pulse width of the carry signal input thereto to be 2T and recognizes that the location of this source driver within the flat panel is the second location. The second source driver adds a predetermined pulse width T to the pulse width of the carry signal and transmits the carry signal having the pulse width 3T to the third source driver. When the carry signal is transmitted to the Nth source driver in this manner, the Nth source driver receives the carry signal having the pulse width N*T and recognizes that the location of this source driver within the flat panel is the Nth location. When the carry signal has been transmitted to the Nth source driver, a gate on signal of one line is finished, an image corresponding to video data of the corresponding line is displayed on the flat panel through the source drivers, and output of video data of the next line is prepared.

The above-described operation is similarly applied to the case where the carry signal is input to the Nth source driver first and shifted to the left. That is, the pulse width of the carry signal input to the Nth source driver is N*T and a predetermined pulse width T is subtracted from the pulse width N*T of the carry signal whenever the carry signal is transmitted to the left source drivers, to thereby recognize locations of the drivers.

In addition, embodiments of the present disclosure can optimize the performance of each of the drivers by varying driving characteristics of the drivers depending on their locations in the flat panel display.

As described above, embodiments of the present disclosure can recognize locations of the various drivers in the flat panel display through input and output signals of the drivers. Moreover, embodiments can vary driving characteristics of each of the drivers depending on driver location in a large flat panel to optimize the performance of each of the drivers. Thus, flat panel display driver embodiments accomplish location compensation of driver signals in flat panel displays.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A flat panel display driver comprising:
a shift register block for receiving an external control signal, at least one of adding and subtracting a predetermined pulse width to or from the pulse width of the received control signal, respectively, in synchronization with a clock signal, performing a driving function, and outputting a control signal having an increased or decreased pulse width, respectively, relative to the received control signal.

2. The driver as claimed in claim 1, wherein the shift register block comprises:
a control signal input unit for receiving the external control signal;
a pulse width detector for detecting the pulse width of the received control signal;
a signal adding/subtracting unit for at least one of adding and subtracting the predetermined pulse width to or from the pulse width of the control signal, respectively; and
a control signal output unit for outputting the resultant control signal having an increased or decreased pulse width, respectively, relative to the received control signal.

3. The driver as claimed in claim 2, wherein the control signal input unit and the control signal output unit exchange their functions with each other depending on a direction in which the control signal is transmitted.

4. The driver as claimed in claim 2, wherein the control signal is output from an external timing controller or an adjacent other driver serially connected to the driver.

5. The driver as claimed in claim 1, wherein the control signal includes a shifting direction select signal and a carry signal, and the addition or subtraction of the pulse width is determined depending on a carry signal shifting direction.

6. The driver as claimed in claim 5, wherein the driver is at least one of a source driver and a gate driver.

7. The driver as claimed in claim 5, wherein the carry signal has different pulse widths for different drivers and the pulse widths represent locations of the respective drivers.

8. A flat panel display driver comprising:
a shift register block for receiving a carry signal output from at least one of an external timing controller and an adjacent driver, and changing the pulse width of the carry signal depending on the location of the driver relative to the locations of other drivers to represent the relative locations of the driver.

9. The driver as claimed in claim 8, wherein the shift register block changes the pulse width of the carry signal by at least one of adding and subtracting a predetermined pulse width to or from the pulse width of the carry signal, respectively.

10. A flat panel display that compensates color data and/or a gate signal based on locations of drivers, by using the drivers claimed in claim 8.

11. The flat panel display as claimed in claim 10, wherein the pulse width of the carry signal input to the drivers is sequentially increased or decreased in response to an arrangement sequence of the drivers.

12. A flat panel driver having a shift register block, the block comprising:
a shift register for determining a signal shifting direction responsive to a state of a control signal;
a first input/output circuit for receiving a first carry signal in response to the state of the control signal, detecting the pulse width of the first carry signal and outputting a first internal signal having a predetermined pulse width to the shift register, or receiving a second internal signal output from the shift register in response to the state of the control signal and outputting the second internal signal as a second carry signal; and
a second input/output circuit for receiving the first internal signal in response to the state of the control signal and outputting the first internal signal as a third carry signal, or receiving a fourth carry signal in response to the state of the control signal, detecting the pulse width of the fourth carry signal and outputting the second internal signal having a predetermined pulse width to the shift register.

13. The driver as claimed in claim 12, wherein the first and second input/output circuits add/subtract a predetermined pulse width to/from the pulse widths of the carry signals input thereto and output the resultant carry signals to the shift register, respectively.

14. The driver as claimed in claim 12, wherein the driver is at least one of a source driver and a gate driver.

15. A driver block including a plurality of drivers for driving a flat panel display, wherein the plurality of drivers are arranged at predetermined intervals and serially connected, and each of the drivers includes at least one bidirectional input/output port, the pulse width of a carry signal output from the bidirectional input/output port of each of the drivers being proportional to a distance between a corresponding driver and a reference driver, a signal shifting direction of the bidirectional input/output port of each of the drivers being decided on the basis of a control signal.

16. The driver block as claimed in claim 15, wherein the distance corresponds to an RC time delay of a signal line.

17. The driver block as claimed in claim 15, wherein the bidirectional input/output port outputs a carry signal having a pulse width that is obtained by adding/subtracting a predetermined pulse width to/from the original pulse width of the carry signal to an adjacent driver.

18. The driver as claimed in claim 15, wherein the drivers are at least one of source drivers and gate drivers.

19. A driving method of a flat panel display driver, comprising:
applying a signal shifting direction select signal and a carry signal to a shift register of the driver;
adding/subtracting a predetermined pulse width to/from the pulse width of the carry signal in response to the signal shifting direction select signal; and
outputting the resultant carry signal to a shift register of an adjacent driver.

20. The driving method as claimed in claim 19 wherein the driver is a first source driver, the driving method further comprising storing color data input from an external device in a first data latch when the carry signal is applied to the first source driver and, when the first data latch is full of the color data, outputting the resultant carry signal to an adjacent source driver and disabling the shift register of the first source driver.

21. The driving method as claimed in claim 19, further comprising judging the pulse width of the carry signal input to the shift register, and judging a location of the driver based on the pulse width of the carry signal.

22. The driving method as claimed in claim 21 wherein the driver is a gate driver, the method further comprising compensating the color data output from a source driver in response to a location of the gate driver.

23. The driving method as claimed in claim 19, wherein adding/subtracting a predetermined pulse width to/from the pulse width of the carry signal includes sequentially accumulating the pulse width of the carry signal as the carry signal is shifted.

24. The driving method as claimed in claim 19, wherein when the resultant carry signal is output to a shift register of an adjacent driver, the shift register receives the signal shifting direction select signal and the carry signal is transmitted in response to the signal shifting direction select signal.

25. The driving method as claimed in claim 19, wherein the carry signal is output from at least one of an external timing controller and an adjacent driver serially connected to the driver.
